(19) United States
(12) Patent Application Publication
(10) Pub. No.: US 2006/0126347 A1
(43) Pub. Date: Jun. 15, 2006

(54) Fitting for a lamp

(76) Inventor: Aarnoud Willem Eversdijk, Den Haag (NL)

Correspondence Address: Norman H Zivin;Cooper & Dunham, 1185 Avenue of the Americas, New York, NY, 10036, US

(21) Appl. No.: 10/522,205

(22) PCT Filed: Jul. 17, 2003
(86) PCT No.: PCT/NL03/00525

§ 371 Date: Aug. 22, 2005

(30) Foreign Application Priority Data
Jul. 18, 2002 (NL) 1021109

(51) Int. Cl. F21V 19/00

(52) U.S. Cl. 362/382

(57) ABSTRACT

The invention relates to a fitting for a lamp, provided with a rim or stop for supporting a lamp cap, and a locking element, such as a nut, for locking a lamp cap onto said rim or stop, the fitting being provided with adjustment means for adjusting the position of the lamp cap with respect to said rim or stop.

The present invention relates to a fitting for a lamp, provided with a rim or stop for supporting a lamp cap, and a locking element, such as a nut, for locking a lamp cap onto said rim or stop, the fitting being provided with adjustment means for adjusting the position of the lamp cap with respect to said rim or stop.

The present invention also relates to an adjustment element, suitable in particular for adjusting the position of a lamp cap with respect to a fitting.

A fitting of this type is known from DE 2 637 784. In this case, the lamp cap can be placed in a number of discrete positions with respect to the remaining structure. U.S. Pat. No. 1,379,066 likewise allows adjustment into various discrete positions.

The fittings used here generally comprise a cylindrical sleeve which is provided with a screw thread on the inner side. This screw thread can be used to allow a bulb to be screwed into the sleeve. The outer side of the sleeve is generally also provided with a screw thread. At that end of the screw thread which is remote from the opening of the sleeve, there is a collar or stop. This collar or stop is intended to have a lamp cap placed onto it. The lamp cap can be placed directly onto the collar. It is also possible for a pedestal to be fitted to the lamp cap, and this pedestal can then be placed onto the rim or stop.

The lamp cap or the pedestal of the lamp cap is fixed to the rim or stop with the aid of a securing element, such as for example a nut. In view of the fact that a screw thread is arranged on the outer wall of the cylindrical element, the nut can be screwed downward in order to clamp the lamp cap or the pedestal of the lamp cap between the underside of the nut and the topside of the rim or stop.

It is known from the prior art to mount a fitting on a support. This support may be a leg which has been specifically produced for this purpose. However, it is also possible for the fitting to be mounted on another item of use, such as for example a vase. In many cases, it is not easy to position a fitting exactly in line with the underside of the support, i.e. in use the fitting, in particular the rim or the stop, forms an angle with respect to the horizontal. In other words, when a lamp cap is placed onto the fitting, the lamp cap is in a skew position with respect to the horizontal.

The object of the present invention is to provide a fitting of the type described above, wherein it is easily and inexpensively possible for the lamp cap to be correctly oriented with respect to the horizontal, i.e. to be positioned in any desired position without incremental steps.

According to the present invention, this object is realised in that said adjustment means comprise a first part, a first end of which is movably connected to said rim or stop, it being possible for the first part to be placed between a first position, substantially parallel to the rim or stop, and a second position at an angle to said rim or stop.

According to the invention, there is provision for an adjustment element to be arranged between the top side of the rim or stop and that side of the lamp cap which faces toward this rim or stop. This adjustment element is movably connected to the rim or stop in such a manner that, depending on the skew position of the fitting with respect to the horizontal, this skew position can be neutralized by moving the adjustment means. This ensures that the skew position of the fitting is corrected with the aid of the adjustment means. This means that in use the lamp cap is in a straight position with respect to the horizontal.

For the sake of clarity, it should be noted that reference is made above to “the horizontal”. Of course, it is also possible for a lamp to be mounted in a position which is such that it deliberately forms an angle with respect to the horizontal. The invention can also be advantageously employed in these situations. The purpose of the invention is to neutralize an undesirable angle between the lamp cap and a support.

For the fitting according to the present invention to operate correctly, it is advantageous for the adjustment means to be provided with locking means for locking the first part in its second position. In this case, it is possible for the first part to be provided with a lug or catch for engaging a recess or groove on the outer side of the fitting.

As has already been stated above, the outer side of the fitting is generally provided with a screw thread. This means that projections formed by the screw thread are present over the length of the fitting. These projections can be used to good effect for the purpose of locking the adjustment means behind these projections. To achieve this, the first part is provided with a lug or catch which can engage behind the projections formed by the screw thread. Additional locking means for locking the first part in its second position are not required.

According to the present invention, there is provision for the parts to be designed in the form or arcs of a circle, in which case the parts describe a complete circle or part of a circle. In this case, there is provision for the parts to be designed such that they describe an arc which is larger than a semicircle and smaller than a complete circle.

Fittings are generally round on the outer side, meaning that the adjustment means are preferably round so that they can be pushed over the fitting and can adjoin the outer wall of the fitting. If there is provision for the parts of the adjustment means to be designed in such a way that they are in the shape of an arc and describe a section of a cylinder which is larger than a semicircle and smaller than a complete circle, it is possible for the parts to be pushed over the outer side of the fitting from one side (if appropriate making use of the flexibility of the parts). This means that it is not necessary for the lamp cap and the locking means to be completely removed from the lamp cap in order to fit the adjustment means.

In addition to the fitting described above, the present invention also relates to an adjustment element for adjusting the position of a lamp cap with respect to a fitting, provided with a first part which is intended to make contact with a lamp cap or the pedestal of a lamp cap, and a second part for supporting the adjustment element on a rim or stop of a fitting, which parts are resiliently or pivotably connected to one another for the purpose of adjusting the angle between said first part and said second part.

The adjustment element according to the present invention is characterized in that the first and second bodies are formed substantially in the form of an arc, for enclosing a cylindrical section of a fitting. In this case, it is advantageous for the parts to be formed in such a way that the arc shape describes a circle which is larger than a semicircle and smaller than a complete circle.

According to the invention, it is also provided that the second part, on the inner side of the arc, is provided with a lug or catch for engaging a groove or recess in the outer side of a fitting.

It is preferable for the adjustment element to comprise spring steel. Making the adjustment element from spring steel means that the adjustment element will automatically be in a wedge shape. The desired wedge shape between the first part and the second part can be set by hand. This desired position can be set by securely clamping the locking means, such as the lug or catch on the first body, around the screw thread on the outer side of the fitting. The lamp cap can then be fixed in the desired position using the adjustment means.

Furthermore, according to the invention, it is possible for the adjustment element to comprise auxiliary arms arranged between the first and second parts, which auxiliary arms absorb spring force during the movement of the first part toward the second part. In this case, it is possible for the auxiliary arms to be punched and flanged out of one of the first and second parts.

Furthermore, according to the invention it is possible for the adjustment element, in the vicinity of the connection between the first and second parts, to be provided with one or more engagement members intended to engage on a lamp cap or a pedestal of a lamp cap. During the positioning of the adjustment element, the engagement member or members can engage securely behind a section of the lamp cap or the pedestal of a lamp cap. The engagement members ensure that, in use, the first part continues to bear against the lamp cap. The lamp cap cannot rotate with respect to said first part.

The present invention will be described in more detail with reference to the appended figures, in which:

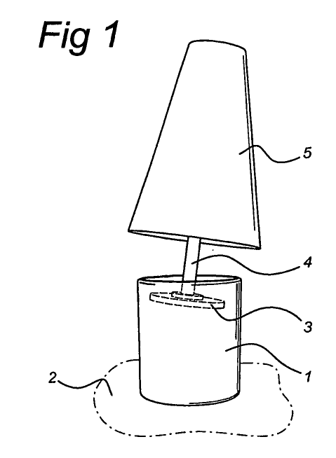

FIG. 1 shows the pedestal of a lamp, with the lamp cap in a skew position with respect to a base.

FIG. 2 shows a detailed view of a fitting on which there is an adjustment element according to the present invention.

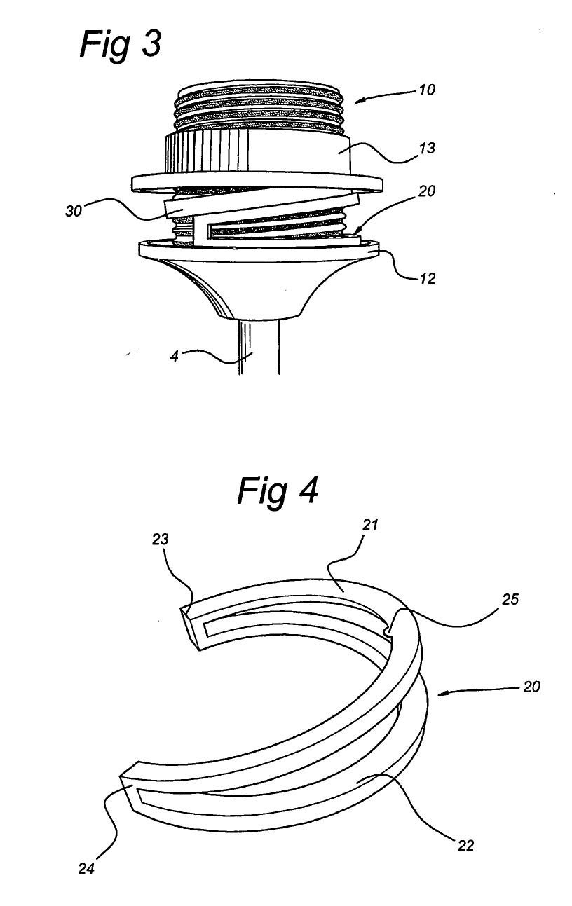

FIG. 3 shows the fitting as shown in FIG. 2 on which there is an adjustment element, a ring and a securing element, such as a nut.

FIG. 4 shows a possible embodiment of the adjustment element according to the invention.

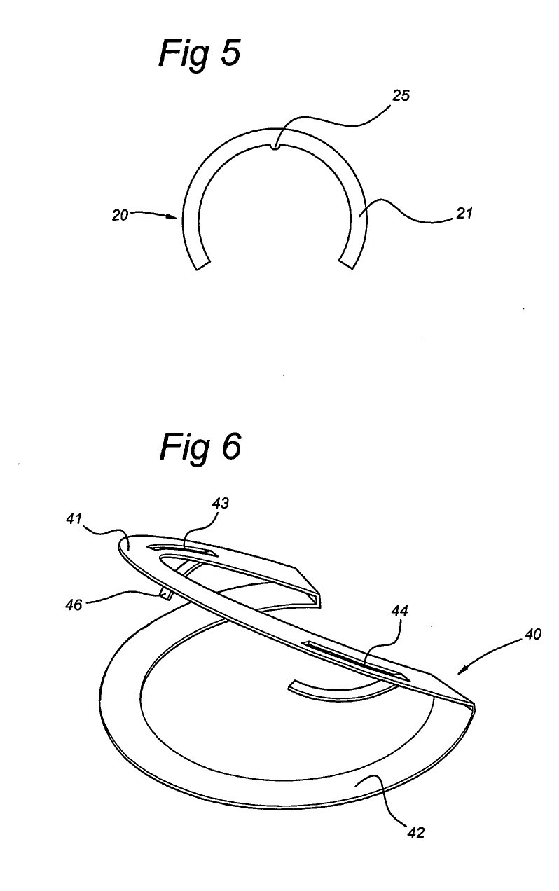

FIG. 5 shows a plan view of the adjustment element shown in FIG. 4.

FIG. 6 shows an alternative embodiment of the adjustment element according to the invention.

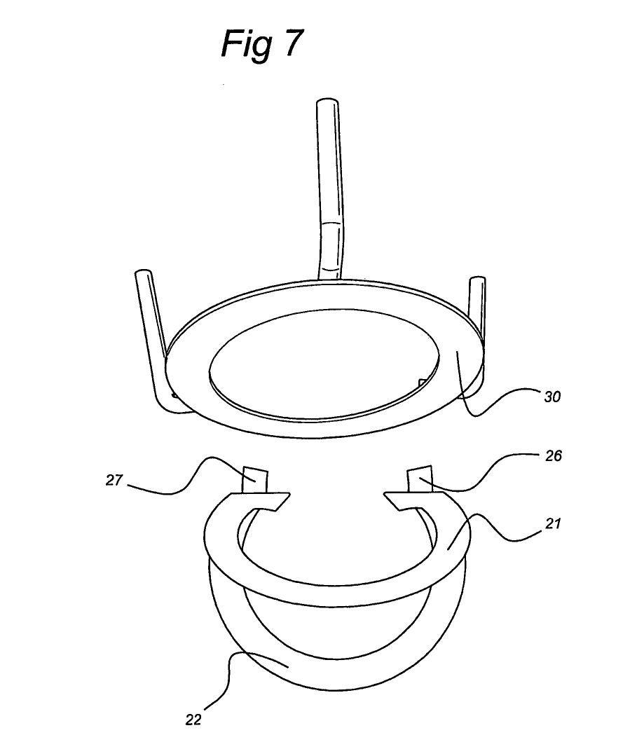

FIG. 7 shows an embodiment in which the adjustment element, in the vicinity of the connection between the first and second parts, is provided with one or more engagement members intended to engage on a lamp cap or a pedestal of a lamp cap.

FIG. 1 shows a lamp according to the prior art. This lamp comprises a pedestal or support 1 which is placed onto a base 2, such as a table. A holder 3 is arranged in the pedestal 1. A stem or tube 4 is mounted on the holder 3. A fitting (not shown) is secured to the top side of this stem or tube 4. The way in which the fitting is secured to the top side of the tube can be seen from FIGS. 2 and 3. A lamp cap 5 is mounted on the fitting. This lamp cap 5 is in line with the tube 4.

Since the holder 3 is in a skew position with respect to the pedestal 1, the tube 4 is also not aligned with the pedestal 1. Consequently, the lamp cap 5 is not aligned with the pedestal 1. This means that the lamp cap 5 is in a skew position with respect to the support 2. According to the present invention, there is provision for the fitting to be modified in such a way that the lamp cap 5 can be positioned aligned straight with respect to the support 2. This is shown in FIGS. 2 and 3.

FIG. 2 depicts part of a fitting 10. This fitting 10 is mounted on the top side of the tube 4 which has already been shown in FIG. 1. The fitting comprises a tubular element 11 which is provided with a screw thread on both the inner side and the outer side. The screw thread on the inner side of the tube 11 is used to allow a bulb to be screwed into the fitting 10. A rim or stop 12 is present on the outer side of the screw thread at the side remote from the opening of the tube 11. A lamp cap or a pedestal of a lamp cap can be placed onto this rim or stop 12. In view of the fact that the outer side of the tube 11 is provided with a screw thread, a securing element, such as a nut 13 (cf. FIG. 3), can be arranged over this screw thread. This nut 13 can be used to clamp a lamp cap between the rim 12 and the nut. To then ensure that the position of a lamp cap which is placed onto the rim 12 can be adjusted, according to the invention an adjustment element 20 is arranged on the rim 12. The various components of the adjustment element are discussed in conjunction with FIGS. 4 and 5. The adjustment element 20 is provided with a first part 21 and a second part 22 shown beneath it. The parts 21 and 22 are connected a their ends at pivot points 23 and 24. For the sake of clarity, it is pointed out that the element 20 shown in the Figures is made from plastic. If, according to a preferred embodiment, the element comprises spring steel, the parts 21 and 22 can be made much thinner. In that case, the overall thickness of the element 20 is much less than the overall thickness shown in the figures.

The parts 21 and 22 are designed in the form of arcs. This can be seen in particular from FIG. 5. The parts describe a section of a circle. The form shown in FIG. 5 beneath the element 20 makes it clear that the parts describe a section of a circle which lies between a semicircle and a complete circle, i.e., in an installed position, the element 20 cannot be removed from the cylindrical element without the parts 21 and 22 having to be deformed. The fact that the parts describe an arc of a circle which is actually larger than a semicircle but smaller than a complete circle means that the parts can be pushed over the cylinder in the bent state. The parts will then spring back under spring force into their original shape, so that the parts close around the cylindrical element 11 and cannot readily be removed from it.

The part 22 is intended to bear against the rim or stop 12. In use, the part 21 comes to bear against a lamp cap or against a pedestal of a lamp cap.

The parts 21 and 22 are movable with respect to one another. As a result of the part 21 being moved with respect to the part 22, it is possible to compensate for a certain amount of skew positioning of the lamp cap with respect to the horizontal step.

To fix the parts 21 and 22 in their desired position, the second part 21 is provided with a lug or catch 25 on the side facing inward. This lug or catch 25 is intended to engage in the screw thread on the outer side of the cylinder 11 (cf. FIG. 2). This allows the parts to be locked with respect to one another in a simple way.

FIG. 3 shows the assembly of a fitting 10 according to the present invention on which there is a nut 13, showing both an adjustment element 20 and a ring 30 between the nut 13 and the rim 12. The ring 30 diagrammatically depicts part of a lamp cap. In normal use, a lamp cap will be secured direct to the ring 30 or the ring 30 will form part of the pedestal of the lamp cap.

FIG. 3 shows that on account of the presence of the element 20 the ring 30 is positioned at an angle with respect to the rim or stop 12, i.e. the skew position of the lamp cap with respect to the horizontal (cf. inter alia FIG. 1) can be corrected by means of the element 20.

FIG. 6 illustrates an alternative embodiment of the element 20 according to the present invention. FIG. 6 shows an adjustment element 40 having a first part 41 and a second part 42 shown beneath it. The element acts in exactly the same way as the adjustment element 20 described above. FIG. 6 shows an embodiment with relatively thin parts made, for example, from spring steel. Cutouts 43 and 44 have been formed in the first part 41 by punching. The material which comes out of these cutouts has been moved downward, so that auxiliary limbs 45 and 46 are formed. When the parts 41 and 42 move toward one another, the underside of these auxiliary limbs 45 and 46 comes into contact with the part 42. The auxiliary limbs increases the spring force holding the parts 41 and 42 at an angle with respect to one another. Obviously, in this embodiment too a lug 25 as shown in the previous embodiments can also be used. The present invention causes a resistance to be imparted when the nut is being tightened. The clamping engagement of the part on the screw thread allows this opposing force to be greater than the spring force of the first part with respect to the second part. As a result, it is possible to make do with a relatively minor spring force between the parts.

FIG. 7 shows a further embodiment of the adjustment element according to the invention, which in the vicinity of the connection between the first and second parts is provided with one or more engagement members 26 and 27 intended to engage on a lamp cap or a pedestal of a lamp cap. In use, the members 26 and 27 are behind the body of the pedestal of a lamp cap 30 or behind a lamp cap (not shown). The material of the members is, for example, punched out of the material of the limbs 21 and 22. On account of this measure, the members 26 and 27 do not form any obstacle to positioning of the element onto a fitting. The members 26 and 27 ensure that, in use, the part 21 bears against the material of the pedestal 30 of the lamp cap or of a lamp cap itself. This ensures correct operation of the adjustment elements.

The invention has been described above on the basis of the use of a plastics material and spring steel. It should be understood that other materials can also be used. Examples of such materials include laminated cardboard provided with a layer of plastic or a metallic product made from wire. Of course, this wire may also be made from spring steel.

1. Fitting for a lamp, provided with a rim or stop for supporting a lamp cap, and a locking element, such as a nut, for locking a lamp cap onto said rim or stop, the fitting being provided with adjustment means for adjusting the position of the lamp cap with respect to said rim or stop, said adjustment means comprising a first part, a first end of which is movably connected to said rim or stop, it being possible for the first part to be placed between a first position substantially parallel to the rim or stop and a second position at an angle to said rim or stop.

2. Fitting as claimed in claim 1, wherein the adjustment means comprise a first and a second part, which parts are pivotably connected to one another, the second part being supported on the rim or stop and it being possible for the first part to be placed between a first position substantially parallel to the second part and a second position at an angle to the second part.

3. Fitting as claimed in claim 1, wherein the adjustment means are provided with locking means for locking the first part in its second position.

4. Fitting as claimed in claim 3, wherein the first part is provided with a lug or catch for engaging a recess or groove on the outer side of the fitting.

5. Fitting as claimed in claim 1, wherein the parts are designed in the shape of an arc, the parts describing a complete circle or a part of a circle.

6. Fitting as claimed in claim 5, wherein the parts are designed such that they describe an arc which is larger than a semicircle and smaller than a complete circle.

7. An adjustment element for a fitting for a lamp, for adjusting the position of a lamp cap with respect to a fitting, provided with a first part which is intended to make contact with a lamp cap or the pedestal of a lamp cap, and a second part for supporting the adjustment element on a rim or stop of a fitting, which parts are resiliently or pivotably connected to one another for the purpose of adjusting the angle between said first part and the said second part.

8. Adjustment element as claimed in claim 7, wherein said first and second parts are formed substantially in the form of an arc, for enclosing a cylindrical section of a fitting.

9. Adjustment element as claimed in claim 8, wherein said parts are shaped such that the arc shape describes a circle which is larger than a semicircle and smaller than a complete circle.

10. Adjustment element as claimed in claim 7, wherein the second part, on the inner side of the arc, is provided with a lug or catch for engaging a groove or recess in the outer side of a fitting.

11. Adjustment element as claimed in claim 7, wherein the adjustment element comprises spring steel.

12. Adjustment element as claimed in claim 7, wherein the adjustment element comprises auxiliary arms arranged between the first part and the second part, which support arms absorb spring force during the displacement of the first part toward the second part.

13. Adjustment element as claimed in claim 12, wherein the auxiliary arms are punched and flanged out of one of the first and second parts.

14. Adjustment element as claimed in claim 7. wherein the adjustment element, in the vicinity of the connection between the first and second parts, is provided with one or more engagement members intended to engage on a lamp cap or a pedestal of a lamp cap.
